(19) United States
(12) Patent Application Publication
(10) Pub. No.: US 2026/0138769 A1
(43) Pub. Date: May 21, 2026

(54) TRANSFER SYSTEM FOR A PACKAGING MACHINE AND METHOD

(71) Applicant: MULTIVAC SEPP HAGGENMÜLLER SE & CO. KG, Wolfertschwenden (DE)

(72) Inventor: Kai EISENACH, Wetter (DE)

(73) Assignee: MULTIVAC SEPP HAGGENMÜLLER SE & CO. KG, Wolfertschwenden (DE)

(21) Appl. No.: 19/390,514

(22) Filed: Nov. 15, 2025

(30) Foreign Application Priority Data
Nov. 19, 2024 (DE) 102024133880.6

(51) Int. Cl. B65B 35/16; B65B 35/24

(52) U.S. Cl. CPC B65B 35/16; B65B 35/24

(57) ABSTRACT

A transfer system for a packaging machine, wherein the transfer system comprises a robot configured for placing products into packaging bases provided along the packaging machine, and a buffer belt that is within reach of the robot and onto which products can be deposited by the robot. The buffer belt is configured for placing products deposited thereon by the robot into packaging bases provided along the packaging machine.

### CROSS-REFERENCE TO RELATED APPLICATIONS

This application claims foreign priority benefits under 35 U.S.C. § 119(a)-(d) to German patent application number 102024133880.6, filed November 19, 2024, which is incorporated by reference in its entirety.

### TECHNICAL FIELD

The present disclosure relates to a transfer system and to a method for placing products into packaging bases.

### BACKGROUND

DE 10201182 A1 discloses a positioning system with a conveyor belt that is configured for depositing products onto a tray. The conveyor belt is configured as a pull-back belt, known in technical circles as a pull nose belt, and is positioned such that its transport or pull-back direction runs perpendicular to a direction of transport of the tray, so that cross feeding onto the tray takes place by way of the conveyor belt. However, this type of cross feeding takes up a lot of space.

In practice, picker lines with a picker and an integrated buffer are also employed as transfer systems for loading packaging bases with products, whereby a performance advantage over picker lines without a buffer can be obtained. Picker lines with integrated buffers can be configured to take up less space overall than picker lines that can be supplied from an external buffer with products temporarily stored therein.

In conventional picker lines with integrated buffers, integrated buffer spaces or buffer belts are used within reach of the picker, which is present, for example, in the form of a delta robot. Supplied products or portions that cannot be placed directly into the packaging unit by the picker form a so-called overflow, which can be transported into the available buffer using the picker. This prevents the product inflow from having to be stopped during normal or increased product supply, which can lead to undesirable backing effects in the operation of machines that are positioned upstream, such as a cutting machine. When the product inflow is minimized, the products or portions temporarily stored in the buffer are then available and can be picked up again by the picker, i.e., collected from the buffer and placed into the packaging units provided so that there are no delays arising at the product outlet. On such picker lines, solely one picker is used to place the products supplied or temporarily stored into the packaging bases provided.

Due to the fact that the picker is used in known picker lines to deposit products into the buffer and, by way of a separate picker motion, also to place the buffered products into the packaging, two picks are performed by the picker for each product for these purposes. The first pick is to deposit the product into the buffer, and the second pick is to later place the buffered product into a package provided. As a result, the availability of the picker at the product infeed is reduced for placing the fed products directly into packaging bases. This can lead to products arriving there being picked up by the picker in a delayed manner and deposited into packaging bases or onto the buffer belt, respectively, which can also slow down the preceding transport or operation of other upstream machines. This problem can arise already with a normal product infeed, and even more so with an increased product infeed.

### SUMMARY

An object of the present disclosure is to address one or more of the above-identified shortcomings of the prior art. This object is satisfied by a transfer system according to the disclosure and by a method according to the disclosure.

The disclosure relates to a transfer system for a packaging machine, wherein the transfer system comprises at least one robot configured for placing products into packaging bases provided along the packaging machine, as well as at least one buffer belt that is within reach of the robot and on which products can be deposited by the robot. The disclosure provides that the buffer belt be configured for placing products deposited thereonto by the robot into packaging bases provided along the packaging machine.

In addition to its actual buffer function, the buffer belt according to the disclosure is therefore available as a placement belt. The buffer belt of the disclosure is therefore available as a buffer placement belt. Consequently, the buffer belt according to the disclosure fulfills a dual function in that it is used both for temporarily storing products deposited thereonto by the robot and for placing the temporarily stored products deposited thereonto by the robot into packaging bases provided. This means that the robot is no longer needed, or if so, only in exceptional cases, for again picking up the products temporarily stored on the buffer belt for placing them into packaging units.

The buffer belt according to the disclosure is an inexpensive way of placing products into packaging bases. In combination with the robot, this results primarily in a more economical and space-saving design for buffering and transferring the products.

Due to the fact that the products are placed in the available packaging bases by the robot and the buffer belt, the availability or operational readiness of the robot at the product infeed increases so that the products arriving there can be picked up the latter more quickly and, in particular, processed more continuously, i.e., they can be placed more quickly either directly into the provided packaging bases or deposited on the buffer belt.

The robot according to the disclosure therefore concentrates on picking up and placing thereto-fed products into packaging trays and on picking up and depositing the thereto-fed products onto the buffer belt. For these purposes, all products are each transferred by only one robot pick, regardless of whether they are placed directly into the packaging bases or initially deposited onto the buffer belt. The robot is no longer needed for placing into packaging bases the products that are temporarily stored on the buffer belt. With a few exceptions, this is done by the buffer belt according to the disclosure itself. This means that the robot is also better prepared for placing new products or portions arriving at the product infeed directly into the packaging bases provided. In other words, there are fewer stops arising in the product feed at the product infeed. The present disclosure thereby facilitates the operation of the robot, since the placement of buffered products can be carried out by the buffer belt independently of the infeed flow.

Due to the fact that, according to the disclosure, both the robot and the buffer belt are used to place products into the packaging bases provided along the packaging machine, several products can even be placed into packaging bases simultaneously if necessary, so that it is in particular easier to load the packaging trays provided along the packaging machine, in particular a predetermined format of packaging bases, with products according to a preset or adaptive machine work cycle. On the one hand, this benefits the packaging machine configured for producing packaging, as it can produce packaging without interruption according to the machine work cycle. On the other hand, a device positioned upstream of the transfer system for transporting the products or for producing cut products or portions, respectively, for example, a slicer, can also operate continuously due to the more continuous transfer of products through the transfer system, so that downtimes can also be reduced there.

Preferably, the buffer belt is arranged as a placement belt above a loading stretch of the packaging machine. The transfer system is, so to speak, located in part in a working region of the packaging machine. This favors a transfer system design with reduced installation space, because, when viewed from above, the loading stretch of the packaging machine overlaps at least in sections with the buffer belt of the transfer system positioned thereabove.

It would be conceivable for the buffer belt to be attachable to a machine frame of the packaging machine in order to assume a predetermined position above the loading stretch. The buffer belt can be aligned in particular longitudinally to the loading stretch so that the buffer belt can be used to feed products longitudinally in the direction of production of the packaging machine into the packaging bases provided along the loading stretch.

An advantageous embodiment of the disclosure provides that the buffer belt can be driven by a pneumatic lifting drive, by an electric motor or by a servo motor for placing products. This allows the products temporarily stored on the buffer belt to be placed precisely into the packaging bases provided. Such a drive can be controlled in particular synchronously with a transport device of the packaging machine, for example, synchronously with transport chains mounted thereon, in order to place products deposited thereonto into the packaging bases during an advancement motion of the packaging bases.

In particular, it is possible to control the buffer belt synchronously with an advancement motion of the packaging machine for placing temporarily stored products and/or to control the robot for placing fed products while the packaging machine continuously performs an advancement motion. This would make it conceivable that products could be placed into stationary packaging trays, in particular by way of the robot, as well as into moving packaging trays, in particular by way of the buffer belt. This allows the placement rate to be increased.

According to one embodiment of the disclosure, the buffer belt is configured for placing the products deposited thereonto by the robot into packaging trays within and/or outside the robot's reach. For these purposes, the buffer belt could be configured as a buffer belt that can be driven in the direction and/or in a direction opposite to the direction of production of the packaging machine.

One variant provides for the buffer belt as such to be arranged such that it is slidable relative to the robot. This function could be used, for example, to specifically free up space for the robot to place products directly, for example, when the buffer function is not needed, at least temporarily, i.e., when there is no overflow. In particular, this function can be used to vary the accessibility of the buffer belt for the robot, i.e., to vary the number of buffer belt locations that can be reached by the robot for depositing products. For example, the buffer belt could be increasingly moved within the robot's reach for increasing the number of buffer belt locations that is within reach of robot in order to accommodate an overflow of products. Conversely, the buffer belt could be increasingly moved out of the robot's reach to reduce the number of buffer belt locations accessible to the robot, thereby freeing up additional space for the robot to place products directly.

Preferably, the buffer belt as such is arranged or movable so that it is slidable out of the robot's reach. This allows the buffer belt to be completely adjusted out of the robot's working region as a unit so that the robot alone is used, at least temporarily, for the direct placement of the products fed thereto. Such a scenario would be advantageous, for example, if it is determined that, due to insufficient product supply at the product infeed of the transfer system, buffering products does not make sense or that the products supplied can be loaded more quickly into the packaging bases by using the robot alone. Moving the buffer belt out of the robot's reach can therefore be used to give the robot its maximum working range for direct placement of the products.

According to one embodiment, the buffer belt has a linear drive that allows it to be adjusted relative to the robot. A servo motor-controlled linear drive would be conceivable in order to be able to position the buffer belt precisely relative to the robot. For practical purposes, a guide for the linear drive could be formed by the machine frame of the packaging machine.

It would be useful to have the positioning of the buffer belt relative to the robot be controlled in an open-loop manner or in a closed-loop manner as a function of the product feed quantity detected. If the quantity of products fed for processing is detected to be so large that there are not enough packaging bases available for processing them, the buffer belt could be positioned, for example, within reach of the robot so that a buffer can be built up thereon. If the product feed decreases, the robot could be used solely for loading the products, i.e., the buffer belt could, be moved, for example partially or completely out of the robot's reach. If the product supply to the transfer system is interrupted, for example, for the reason that a cutting machine positioned upstream has to be newly loaded with a product to be cut, the buffer can be dismantled by moving the buffer belt to the location or locations of unloaded packaging bases in order to place the products temporarily stored thereon into the empty packaging bases.

Preferably, the ratio of products per machine cycle of the packaging machine placed by the robot and by the buffer belt depends on a detected product feed quantity of products into the transfer system.

One variant provides for the robot to be configured as a delta robot. This robot, also known as a picker in technical circles, is ideal for picking up and placing products into packaging bases that have been provided, even if the products are provided irregularly. In addition, the rod kinematics of a delta robot for loading food products ensure hygienic operation.

Preferably, the transfer system for the robot has at least one product feed, which is present in particular in the form of an infeed belt. From the former, the products can be easily picked up by the robot and transferred to the packaging bases provided or be deposited on the buffer belt. The product feed can run parallel to a loading stretch of the packaging machine so that the products can be transferred from the transfer system to the packaging machine in a confined space.

According to one embodiment, the transfer system has at least one vision system that is associated with the product feed in order to be able to detect products transported thereon. Based on a product feed quantity detected by the vision system, the operation of the robot in particular can be controlled. Preferably, the interaction between the robot and the buffer belt, for example, the positioning of the buffer belt relative to the robot, can vary as a function of the detected product feed quantity.

Preferably, the infeed belt is positioned immediately adjacent to the packaging machine, in particular, immediately adjacent to and parallel to a loading stretch formed thereon, so that the robot has to travel short distances between the infeed belt and the loading stretch for placing products.

One variant provides for the infeed belt to be controllable as a placement belt in order to place products into packaging bases itself. In this variant, the robot, the buffer belt, as well as the infeed belt could therefore be used to place products into the packaging bases provided. For this purpose, an end of the infeed belt facing the packaging machine could be positioned above the loading stretch in order to place products into the packaging bases provided along the loading stretch.

According to one embodiment it is provided the buffer belt is a pull-back belt or a conveyor belt. In a preferred variant, the buffer belt can be used as a pull-back belt and as a conveyor belt to place products into packaging bases. As a conveyor belt, the buffer belt can be driven synchronously with an advancement motion of the packaging machine in the direction of production of the packaging machine in order to place products deposited thereon into packaging bases moved along the packaging machine during the advancement motion of the packaging machine. If the buffer belt is configured as a pull-back belt, then the pull-back belt can be in particular retracted and extended longitudinally to a direction of production of the packaging machine.

According to one variant, it is provided in particular that the buffer belt in the form of a pull-back belt has an end that can be retracted in the direction of production of the packaging machine. This allows the products to be placed gently into the packaging bases provided therebelow.

The pull-back belt is preferably configured as a double-sided pull-back belt with oppositely disposed retractable and extendable ends. Such a pull-back belt can additionally support the picker when placing products into the packaging bases provided.

One variant provides for the buffer belt to have several buffer belt tracks that can be controlled independently of one another. This allows the respective tracks each running in the direction of production to be filled with products independently of one another from packaging bases provided along the loading stretch.

Preferably, the buffer belt and/or the infeed belt can be controlled to place several products into packaging bases at the same time, in particular to place several products at the same time into a row of several packaging bases disposed transverse to the direction of production of the packaging machine. This allows packaging bases to be loaded with products in rows by way of the buffer belt and/or by way of the feed belt.

One variant provides that possible complete loading of a row of packaging bases provided and running transverse to the direction of production of the packaging machine by way of the buffer belt can be controlled with priority over individual loading by way of the robot of the packaging bases disposed in the row. This results in gentle operation for the robot and reduces energy-intensive power peaks of the robot.

It would be conceivable for the transfer system to have a further buffer belt onto which products can be deposited by the robot, where the further buffer belt is also configured for placing products deposited thereonto by the robot into packaging bases provided along the packaging machine. This allows the buffer capacity to be increased or distributed across several buffer belts, respectively.

In particular, the two buffer belts are arranged relative to each other in such a way that they leave a space between them in which packaging bases are provided for the robot for direct placement of products. This creates a working window, possibly of varying size, between the two buffer belts for the robot in which the latter can place products directly into the packaging bases provided therein.

It would be conceivable for the transfer system to comprise another robot, in particular a delta robot, which is configured for placing products into packaging bases provided along the packaging machine and for depositing products on the further buffer belt. This allows two pairs of robot-buffer belts to be formed within the transfer system, each of which comprises both a robot and a buffer belt that can be used to place products into packaging bases provided along the packaging machine. According to such a paired configuration, the transfer system can process particularly large quantities of product per time, in particular compensate for highly varying product inflow rates.

It would be conceivable for both buffer belts to be configured as pull-back belts or as conveyor belts or as a combination thereof. It would be conceivable for the buffer belts to be controllable with a time delay for placing into the packaging bases provided the products deposited thereon by the robot(s). For example, it would be conceivable for one of the two buffer belts to be controllable during an interruption in the advancement motion of the packaging machine in order to place products deposited thereonto into the packaging bases provided. The other of the two pull-back belts, on the other hand, could be controlled during an advancement motion of the packaging machine for place products into the moving packaging bases synchronously with the advancement motion.

According to one embodiment of the disclosure, the retractable and extendable ends of the two pull-back belts face each other. Such a structure can be used, for example, to leave between the facing ends of the pull-back belts a working window for the robot within which the robot can be used to place products directly.

In particular, both pull-back belts are arranged such that they are slidable relative to the robot or robots, respectively. This could be used, for example, to vary the placement region of the respective robot, in particular as a function of a product supply detected.

The disclosure also relates to a production line with a transfer system according to the disclosure and at least one packaging machine configured in the form of a deep-drawing packaging machine or a tray sealing machine. The transfer system is configured for placing products into packaging bases provided along the packaging machine. For this purpose, a robot as well as a buffer belt of the transfer system that is that is within reach of robot are used.

It would be conceivable for several packaging machines within the production line to be supplied with products by the transfer system, for example, two deep-drawing packaging machines arranged parallel to each other. The robot could be used at both packaging machines and the transfer system could provide at least one buffer belt for the respective packaging machines for placing products that have been deposited thereonto by the robot and temporarily stored. This allows for supplied products to be distributed to the respective packaging machines by the transfer system.

Preferably, the production line comprises in the direction of production upstream of the transfer system at least one cutting device for cutting the products. The transfer system can be used to process regular and irregular product flows from the cutting device so that both the cutting device as well as the packaging machine can operate continuously, in particular with regard to a desired machine operating cycle.

Preferably, the buffer belt is mounted on a machine frame of the packaging machine, in particular mounted thereon along a loading stretch of the packaging machine to be slidable in a direction and opposite to a direction of production of the packaging machine.

On the packaging machine, the buffer belt forms, in particular, a buffer placement belt positioned above the loading stretch which is, in particular, displaceable relative to the robot.

The disclosure also relates to a method in which a robot is used to place products into packaging bases provided along at least one packaging machine. The method according to the disclosure further provides that at least one buffer belt be used to place products deposited thereonto by the robot into packaging bases provided along the packaging machine.

Consequently, in the disclosure, the buffer belt provided for the robot is also used as a placement belt for placing the products deposited thereonto by the robot and temporarily stored into the packaging bases provided along the packaging machine. The buffer belt according to the disclosure then fulfills a dual function by being used both as a buffer belt and as a placement belt.

A significant advantage of the method according to the disclosure is that the robot is no longer needed for picking up products from the buffer and placing them into the packaging bases. Instead, its work can be confined to the immediate placement of products into the packaging bases provided and to depositing of products on the buffer belt, so that products are no longer picked up by the robot several times but each product is picked up and deposited by the robot only once. This increases the availability of the robot at the product infeed for the products being fed in. This promotes an uninterrupted product feed into the transfer system as well as a continuous packaging process because the robot is no longer needed to clear occupied buffer spaces.

It would be conceivable to use a further buffer belt for placing products deposited thereonto by the robot into packaging bases provided along the packaging machine. In particular, it would be possible for the two buffer belts to be used on different packaging machines for placing products deposited thereonto by the robot into packaging bases provided along the respective packaging machines.

### BRIEF DESCRIPTION OF THE DRAWINGS

The disclosure shall be explained in more detail using embodiments shown in the figures, where:

FIG. 1 shows a transfer system for a packaging machine in the form of a deep-drawing packaging machine;

FIG. 2 shows a transfer system for a packaging machine in the form of a deep-drawing packaging machine;

FIG. 3 shows a transfer system for a packaging machine in the form of a deep-drawing packaging machine in a perspective view;

FIG. 4A shows a transfer system for a packaging machine in the form of a tray sealing machine;

FIG. 4B shows the transfer system from FIG. 4a during ongoing operations;

FIG. 5 shows a schematic top view of a transfer system for a deep-drawing packaging machine;

FIG. 6 shows a further transfer system in a schematic top view for a deep-drawing packaging machine;

FIG. 7 shows a further transfer system in a schematic top view for a deep-drawing packaging machine; and

FIG. 8 shows a further transfer system in a schematic top view for a deep-drawing packaging machine.

Identical technical features are provided with the same reference numerals throughout the figures.

### DETAILED DESCRIPTION

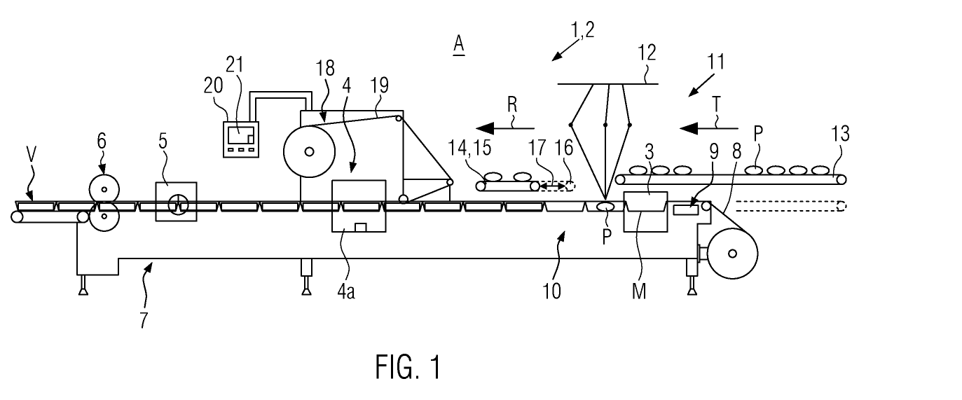

FIG. 1 shows a schematic side view of a production line A with a packaging machine 1 configured as an intermittently operating deep-drawing packaging machine 2. Deep-drawing packaging machine 2 comprises a forming station 3, a sealing station 4, a transverse cutting station 5, and a longitudinal cutting device 6 which are arranged in a direction of transport R in this order on a machine frame 7. Disposed on the input side on machine frame 7 is a supply roller from which a film web 8 as a base film is drawn off. Furthermore, deep-drawing packaging machine 2 comprises a transport chain 9 which grips film web 8 and transports it onward in direction of production R per machine work cycle.

In the embodiment shown, forming station 3 is configured as a deep-drawing station in which tray-like packaging bases M are formed into film web 8 by deep-drawing, for example, by way of compressed air and/or vacuum. Forming station 3 can be configured in such a way that several packaging bases M are formed adjacent to each other in the direction perpendicular to direction of production R, i.e., a row of several packaging bases is present.

Provided in direction of production R downstream of forming station 3 is a loading stretch 10 in which packaging bases M formed into film web 8 are filled with products P.

Filling the trays or packaging bases M with products P is carried out in FIG. 1 by way of a transfer system 11.

Transfer system 11 comprises a robot 12 which picks up products P from a product feed 13 and places them into manufactured packaging bases M in the region of loading stretch 10. Furthermore, transfer system 11 comprises a buffer belt 14 on which products P can be deposited by way of robot 12.

According to FIG. 1, in addition to its buffer function, buffer belt 14 is also used as a placement belt so that products P deposited thereonto can be placed into packaging bases M. For this purpose, buffer belt 14 is arranged above loading stretch 10 of deep-drawing packaging machine 2. Buffer belt 14 from FIG. 1 is provided as a pull-back belt 15 that can be extended and retracted longitudinally relative to direction of production R of deep-drawing packaging machine 2, in particular having an end 16 that can be retracted in direction of production R of deep-drawing packaging machine 2. Such a pull-back belt 15 is also known in technical circles as a “pull nose belt.” End 16 formed on pull-back belt 15 shown in FIG. 1 is extended and retracted by way of a pneumatic lifting drive 17.

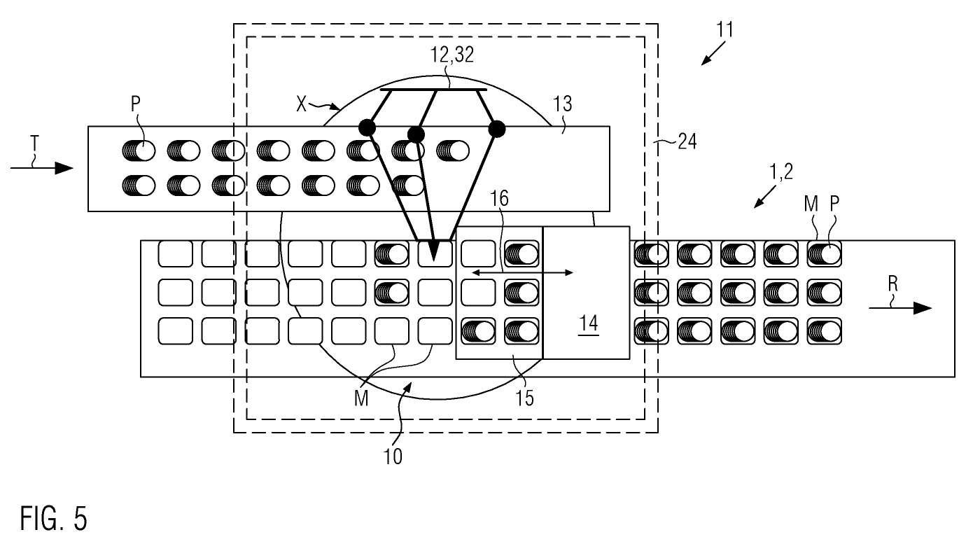

According to FIG. 1, product feed 13 is provided as a feed and placement belt which ends above loading stretch 10 in order to be able to fill packaging bases M transported out from forming station 3 with products P. As an alternative to this arrangement, which is shown by the dashed representation of product feed 13, product feed 13 can be mounted lower and run adjacent to packaging machine 1, in particular adjacent to loading stretch 10, for example, up to buffer belt 14 (see FIG. 5), in order to be used solely as a product feed 13 for robot 12, i.e., without itself providing a placement function.

Sealing station 4 comprises a hermetically sealable chamber 4a in which the atmosphere in tray-like packaging bases M can be evacuated and/or replaced by gas flushing with a replacement gas or a gas mixture before being sealed with a film web 19 delivered from a top film holder 18.

Transverse cutting device 5 can be configured as a punch that cuts sealed film webs 8, 19 in a direction transverse to direction of production R between adjacent packaging bases M. Transverse cutting device 5 operates in such a way that film web 8 is not cut across its entire width, but is not severed at least in an edge region. This enables controlled onward transportation by transport chain 9.

Longitudinal cutting device 6 can be configured as a blade device with which sealed film webs 8, 19 are severed between adjacent trays M and at the lateral edge of film web 8 formed as the base film in direction of production R, so that separated packaging units V are present downstream of longitudinal cutting device 6.

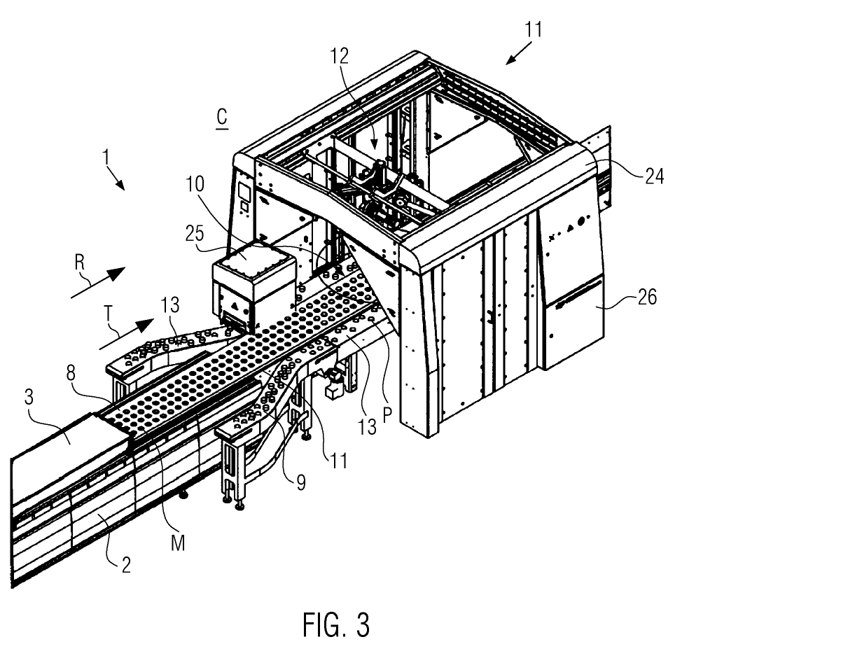

Deep-drawing packaging machine 2 furthermore comprises a control device 20. Its task is to control and monitor the processes running in deep-drawing packaging machine 2. A display device 21 is used for the visualization or influence of the process sequences in deep-drawing packaging machine 2 for or by an operator. It is conceivable that transfer system 11 is connected to control device 20 so that the respective components of transfer system 11 can be controlled by way of control device 20. Alternatively, transfer system 11 can also comprise its own control device 26 (see FIG. 3).

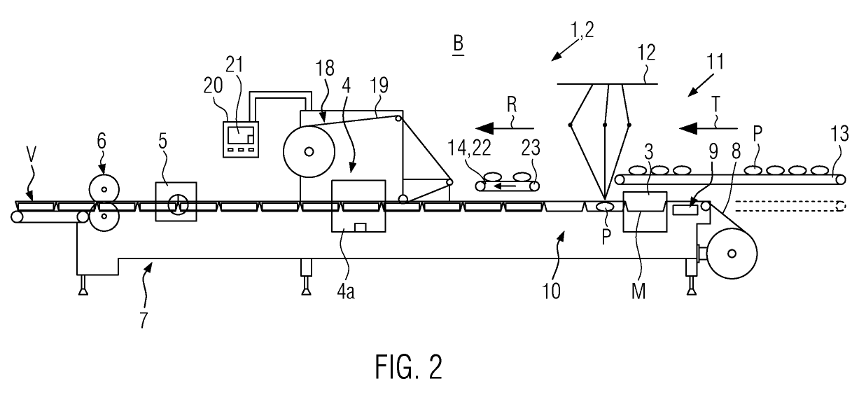

FIG. 2 shows a schematic side view of a production line B, where transfer system 11 used therein differs from transfer system 11 shown in FIG. 1 in that it comprises, instead of pull-back belt 15, a conventional conveyor belt 22 as a buffer belt 14. Conveyor belt 22 is configured in particular to transport products P temporarily stored thereon by way of robot 12 in direction of production R in order to place products P temporarily stored thereon into the packaging bases or trays M provided along deep-drawing packaging machine 2 as required. Conveyor belt 22 shown in FIG. 2 is driven by a servo motor 23, in particular synchronously with an advancement motion of deep-drawing packaging machine 2, in order to place products P into the packaging bases or trays M provided along deep-drawing packaging machine 2.

In the event that product feed 13 shown in FIG. 2 runs below and next to loading stretch 10 as shown by the dashed line, buffer belt 14 shown in FIG. 2 could also be positioned above forming station 3 such that it ends above loading stretch 10 instead of product feed 13, in order to be able to fill packaging bases M transported out from forming station 3 with products P.

FIG. 3 shows a schematic side view of a production line C, in particular a sectional view of deep-drawing packaging machine 2 used therein in perspective. At the beginning, on the left-hand side in FIG. 3, deep-drawing packaging machine 2 comprises forming station 3 in which packaging bases or trays M are formed into film web 8 and into which products P are placed. Arranged above loading stretch 10 is a gantry 24 with robot 12 for picking up products P from product feed 13 and placing them into packaging bases M.

Arranged in direction of production R upstream of loading stretch 10 is a vision system 25 for product feed 13 for detecting the position and/or quantity of products P on product feed 13. Based on the values detected, robot 12 is controlled by way of control system 26 so that it can reliably pick up products P from product feed 13 and place them into packaging bases M in the correct position. A further vision system 25 of oppositely disposed product feeder 13 is not shown for reasons of better illustration. Not shown in detail in FIG. 3 are the work stations following downstream of loading stretch 10, namely sealing station 4 for applying film web 19, transverse cutting station 5, and longitudinal cutting device 6. In addition, buffer belt 14 of transfer system 11 located above loading stretch 10 is covered by gantry 24 in FIG. 3 so that it cannot be seen.

According to FIG. 3, direction of production R of film web 8 is aligned with a direction of transport T of products P on product feed 13, i.e., is in synchronous operation. It is also conceivable that product feed 13 feeds products P to loading stretch 10 in the opposite run.

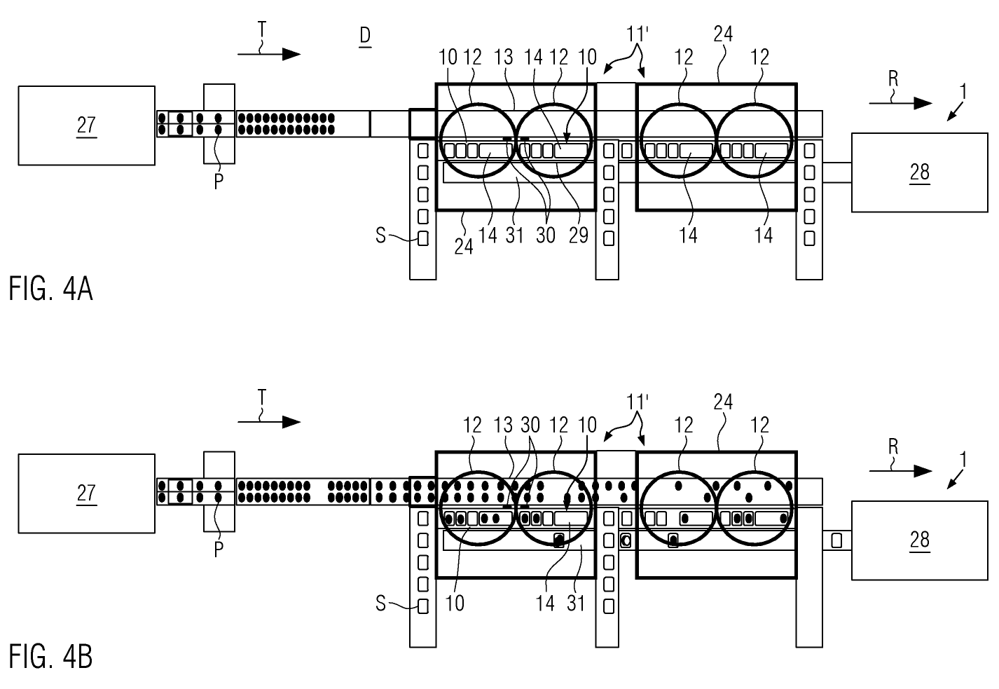

FIG. 4A shows a production line D with a cutting device 27 (e.g., a blade or knife) for cutting products P, a transfer system 11' for placing products P into available tray-shaped packaging bases S, as well as a packaging machine 1 in the form of a tray sealing machine 28, which are arranged one behind the other in this order in direction of production R.

Products P cut by cutting device 27 are transported in direction of production R via product feed 13 to a working region of transfer system 11' in accordance with FIG. 4A. Within the working region of transfer system 11', fed products P can be picked up by product feed 13 using robots 12 arranged therein and placed into packaging bases S provided. Packaging bases S are provided along loading stretch 10 by way of a tray feed 29.

Furthermore, arranged within reach of respective robots 12 above loading stretch 10 are buffer belts 14 on which products P can be deposited by robots 13 as shown in FIG. 4A. These buffer belts 14 are capable of placing products P that are temporarily stored thereon into packaging bases S provided along loading stretch 10 and are therefore used as placement belts.

Transfer system 11' from FIG. 4A comprises a pusher unit 30 which serves to push packaging bases S loaded with product P from tray feed 29 onto an outfeed belt 31 transverse to direction of production R. According to FIG. 4A, outfeed belt 31 also forms a feed for tray sealing machine 28 positioned downstream, within which packaging bases S loaded with product P can be sealed with a top film.

FIG. 4B shows production line D in advanced operation, where products P are already being loaded by way of transfer system 11'. In particular, FIG. 4B shows that products P are placed directly into packaging bases S provided along loading stretch 10 by way of robots 12 as well as temporarily stored on buffer belts 14, for example, to absorb an overflow of products P. For example, in the event of a slowdown in product supply, products P temporarily stored on buffer belts 14 are placed as required from the belts into packaging bases S provided.

In transfer system 11', robots 12 as well as respective buffer belts 14 are used to place fed products or to place temporarily stored products P into packaging bases S provided.

FIG. 5 shows transfer system 11 in a schematic top view for supplying deep-drawing packaging machine 2 with products P. Transfer system 11 uses robot 12, which is a delta robot 32, to place products P into packaging bases or trays M provided, and buffer belt 14, which is provided as a pull-back belt 15 according to FIG. 5, to place temporarily stored products P, i.e., products P that have been deposited onto buffer belt 14 by robot 12, into trays M.

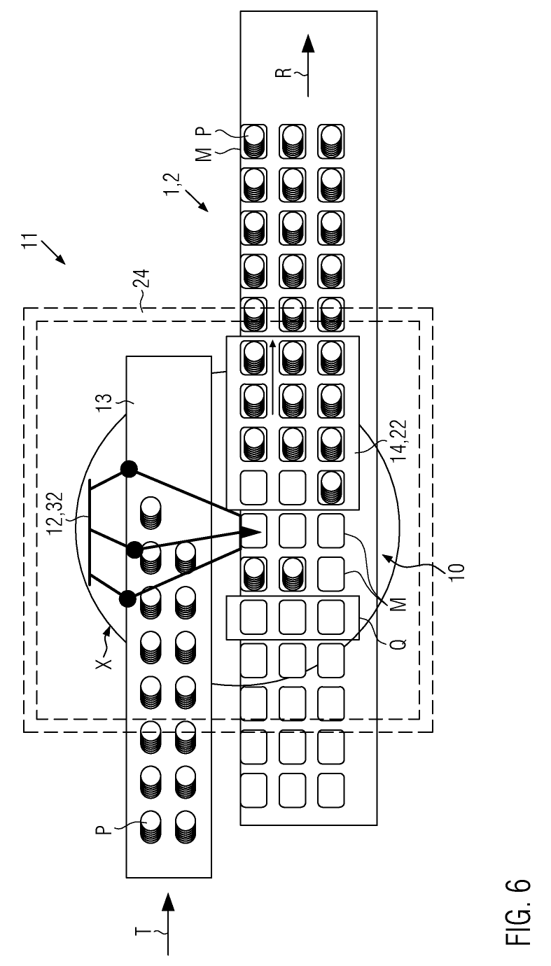

In FIG. 6, conveyor belt 22 is provided in transfer system 11 as a buffer belt 14 and is configured to convey products P deposited thereonto by robot 12 in direction of production for placing them into trays M provided therebelow along loading stretch 10.

Conveyor belt 22 can be loaded by robot 12 such that it can be controlled for complete loading of a row Q of several packaging bases M running transverse to direction of production R once row Q has reached one end of conveyor belt 22. For this purpose, row Q can be transported empty past robot 12 without being loaded by the latter.

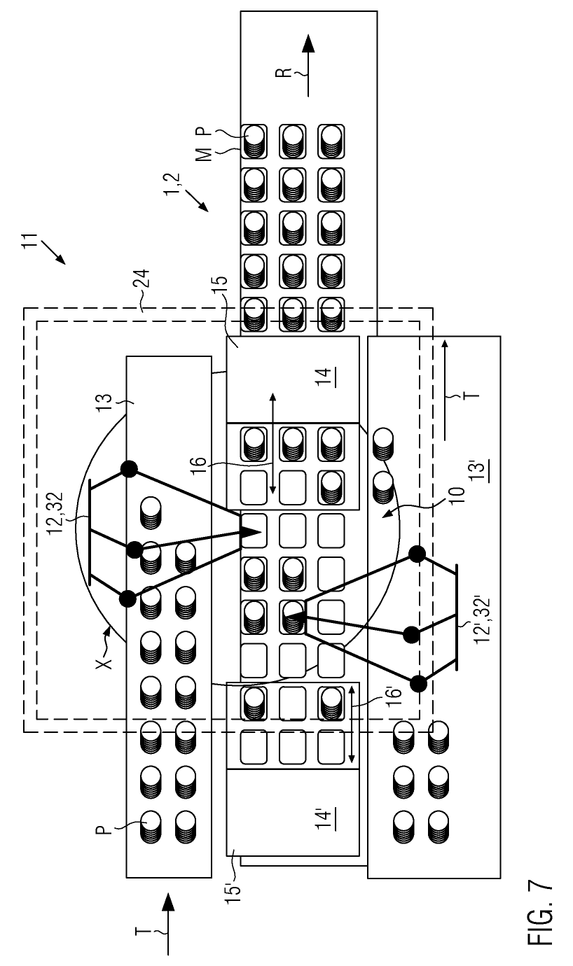

FIG. 7 shows that transfer system 11 comprises a further buffer belt 14' on which products P can be deposited by a further robot 12'. Further buffer belt 14' is also configured for placing products P deposited thereonto by robot 12' into packaging bases M provided along deep-drawing packaging machine 2

According to FIG. 7, further buffer belt 14' is also provided as a pull-back belt 15' which also has a retractable and extendable end 16'. FIG. 7 also shows that further robot 12' receives products P from a product feed 13' disposed opposite to product feed 13. Further product feed 13' also feeds products P in direction of transport T to transfer system 11.

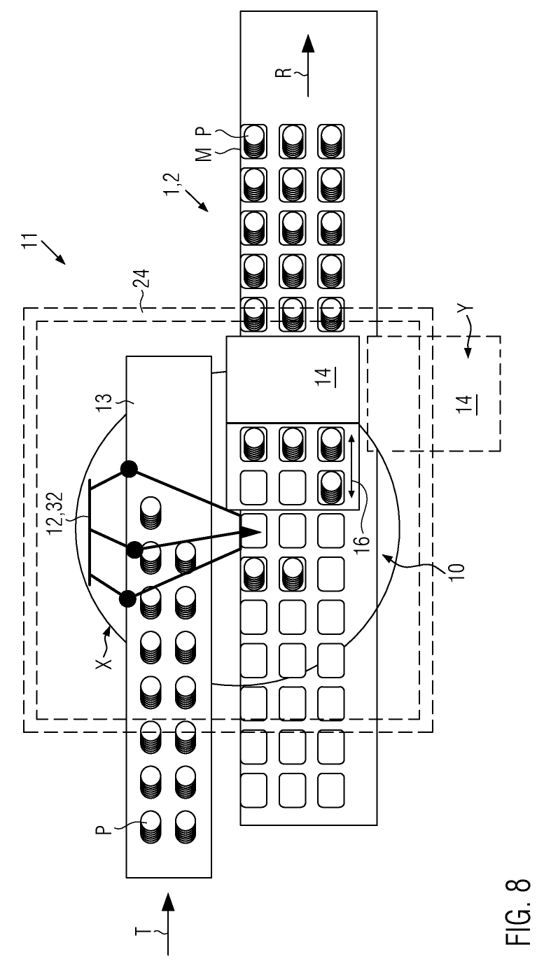

FIG. 8 shows in a schematic top view that buffer belt 14 can be moved out of a working region X of robot 12 to a zone Y so that robot 12 disposes of a maximum working range for placing products P directly into packaging bases or trays M provided.

What is claimed is:

1. A transfer system for a packaging machine, wherein the transfer system comprises a robot configured for placing products into packaging bases provided along the packaging machine, and a buffer belt that is within reach of the robot and onto which products can be deposited by the robot, wherein the buffer belt is configured for placing products deposited thereon by the robot into packaging bases provided along the packaging machine.

2. The transfer system according to claim 1, wherein the buffer belt is arranged as a placement belt above a loading stretch of the packaging machine.

3. The transfer system according to claim 1, wherein the buffer belt is drivable by a pneumatic lifting drive, by an electric motor, or by a servo motor for placing products.

4. The transfer system according to claim 1, wherein the buffer belt is arranged as such to be slidable relative to the robot.

5. The transfer system according to claim 4, wherein the buffer belt is arranged to be slidable out of reach of the robot.

6. The transfer system according to claim 1, wherein the robot is configured as a delta robot.

7. The transfer system according to claim 1, further comprising at least one product feed for the robot.

8. The transfer system according to claim 1, wherein the buffer belt is a pull-back belt or a conveyor belt.

9. The transfer system according to claim 8, wherein the buffer belt comprises the pull-back belt, and the pull-back belt is extendable and retractable longitudinally relative to a direction of production of the packaging machine.

10. The transfer system according to claim 9, wherein the pull-back belt has an end that is retractable in the direction of production of the packaging machine.

11. The transfer system according to claim 8, wherein the buffer belt comprises the pull-back belt, and the pull-back belt is configured as a double-sided pull-back belt with oppositely disposed retractable and extendable ends.

12. The transfer system according to claim 1, further comprising a further buffer belt onto which products can be deposited by the robot, wherein the further buffer belt is also configured for placing products deposited thereonto by the robot into packaging bases provided along the packaging machine.

13. The transfer system according to claim 12, further comprising a further robot, which is configured for placing products into packaging bases provided along the packaging machine and for depositing products onto the further buffer belt.

14. A production line comprising the transfer system according to claim 1 and at least one packaging machine configured as a deep-drawing packaging machine or a tray sealing machine.

15. The production line according to claim 14, wherein the production line comprises at least one cutting device for cutting the products in a direction of production upstream of the transfer system and/or the buffer belt is mounted on a machine frame of the packaging machine.

16. The production line according to claim 15, wherein the buffer belt is mounted on the machine frame and is slidable in the direction of production of the packaging machine along a loading stretch of the packaging machine.

17. A method for placing products into packaging bases, the method comprising:
using a robot to place products into packaging bases provided along a packaging machine; and
using a buffer belt for placing products deposited thereonto by the robot into packaging bases provided along the packaging machine.

18. The method according to claim 17, wherein furthermore a further buffer belt is used for placing products deposited thereonto by the robot into packaging bases provided along the packaging machine.
